(19) United States
(12) Patent Application Publication
(10) Pub. No.: US 2025/0056450 A1
(43) Pub. Date: Feb. 13, 2025

(54) TIMING ADJUSTMENT METHOD, CONFIGURATION METHOD, APPARATUS, AMPLIFIER, AND BASE STATION

(71) Applicant: VIVO MOBILE COMMUNICATION CO., LTD., Guangdong (CN)

(72) Inventors: Shuyan PENG, Guangdong (CN); Huan WANG, Guangdong (CN)

(73) Assignee: VIVO MOBILE COMMUNICATION CO., LTD., Guangdong (CN)

(21) Appl. No.: 18/928,577

(22) Filed: Oct. 28, 2024

Related U.S. Application Data
(63) Continuation of application No. PCT/CN2023/091596, filed on Apr. 28, 2023.

(30) Foreign Application Priority Data
Apr. 28, 2022 (CN) 202210471494.6

(51) Int. Cl. H04W 56/00; H04L 27/26; H04W 80/02

(52) U.S. Cl. CPC H04W 56/0015; H04L 27/26025; H04W 56/0045; H04W 80/02

(57) ABSTRACT

This application discloses a timing adjustment method, a configuration method, an apparatus, an amplifier, and a base station. The timing adjustment method in embodiments of this application includes: The amplifier determines timing of a mobile termination MT and/or a radio unit RU of the amplifier based on at least one of the following: a predefined mode, a preconfigured mode, or obtained first information.

### CROSS-REFERENCE TO RELATED APPLICATIONS

This application is a Bypass continuation application of PCT International Application No. PCT/CN2023/091596 filed on Apr. 28, 2023, which claims priority to Chinese Patent Application No. 202210471494.6, filed on Apr. 28, 2022 in China, which is incorporated herein by reference in its entirety.

### TECHNICAL FIELD

This application pertains to the field of communication technologies, and specifically relates to a timing adjustment method, a configuration method, an apparatus, an amplifier, and a base station.

### BACKGROUND

In a related technology, signal amplifiers amplify and forward uplink and downlink signals of a full carrier based on uplink and downlink frame structure configurations, regardless of whether the carrier carries a signal that needs to be forwarded. In a case that no signal needs to be forwarded, the signal amplifiers amplify surrounding noise and affect performance of data transmission in a system. Considering that network-controlled amplifiers have a plurality of link states, interference between symbols/slots can be reduced only if transmitting/receiving is well performed.

### SUMMARY

Embodiments of this application provide a timing adjustment method, a configuration method, an apparatus, an amplifier, and a base station.

According to a first aspect, a timing adjustment method is provided, including the following step.

An amplifier determines timing of a mobile termination MT and/or a radio unit RU of the amplifier based on at least one of the following: a predefined mode, a preconfigured mode, or obtained first information.

According to a second aspect, a configuration method is provided, including the following step.

A base station sends fourth information to an amplifier, where the fourth information is used to configure or indicate a signal transmit-receive conversion time of the amplifier.

According to a third aspect, a timing adjustment apparatus is provided, including:
a determining module, configured to determine timing of an MT and/or an RU of an amplifier based on at least one of the following: a predefined mode, a preconfigured mode, or obtained first information.

According to a fourth aspect, a configuration apparatus is provided, including:
a sending module, configured to send fourth information to an amplifier, where the fourth information is used to configure or indicate a signal transmit-receive conversion time of the amplifier.

According to a fifth aspect, an amplifier is provided. The amplifier includes a processor and a memory, the memory stores a program or an instruction that can be run on the processor, and the program or the instruction is executed by the processor to implement the steps of the method according to the first aspect.

According to a sixth aspect, an amplifier is provided, including a processor and a communication interface. The processor is configured to determine timing of an MT and/or an RU of the amplifier based on at least one of the following: a predefined mode, a preconfigured mode, or obtained first information.

According to a seventh aspect, a base station is provided. The base station includes a processor and a memory, the memory stores a program or an instruction that can be run on the processor, and the program or the instruction is executed by the processor to implement the steps of the method according to the second aspect.

According to an eighth aspect, a base station is provided, including a processor and a communication interface. The communication interface is configured to send fourth information to an amplifier, where the fourth information is used to configure or indicate a signal transmit-receive conversion time of the amplifier.

According to a ninth aspect, a communication system is provided, including an amplifier and a base station. The amplifier may be configured to perform the step of the method according to the first aspect, and the base station may be configured to perform the step of the method according to the second aspect.

According to a tenth aspect, a readable storage medium is provided, where the readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface. The communication interface is coupled to the processor, and the processor is configured to run a program or an instruction, to implement the steps of the method according to the first aspect or the steps of the method according to the second aspect.

According to a twelfth aspect, a computer program/program product is provided. The computer program/program product is stored in a storage medium, and the computer program/program product is executed by at least one processor to implement the steps of the method according to the first aspect or the steps of the method according to the second aspect.

### BRIEF DESCRIPTION OF DRAWINGS

FIG. 1 is a block diagram of a wireless communication system to which the embodiments of this application may be applied;

FIG. 2 is a schematic diagram of a network structure according to an embodiment of this application;

FIG. 3A is a schematic diagram of a downlink according to an embodiment of this application;

FIG. 3B is a schematic diagram of an uplink according to an embodiment of this application;

FIG. 4 is a flowchart of a timing adjustment method according to an embodiment of this application;

FIG. 5 is a flowchart of a configuration method according to an embodiment of this application;

FIG. 6 is a schematic diagram of timing in Embodiment 1 of this application;

FIG. 7 is a schematic diagram of timing in Embodiment 2 of this application;

FIG. 8 is a schematic diagram of a structure of a timing adjustment apparatus according to an embodiment of this application;

FIG. 9 is a schematic diagram of a structure of a configuration apparatus according to an embodiment of this application; and

FIG. 10 is a schematic diagram of a structure of a communication device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in this specification and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6th generation (6G) communication system.

FIG. 1 is a block diagram of a wireless communication system to which the embodiments of this application may be applied. The wireless communication system includes terminals 11 and a network side device 12. The terminal 11 may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, or a smart chain anklet), a smart wrist strap, smart clothing, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point (AP), a wireless fidelity (Wi-Fi) node, or the like. The base station may be referred to as a NodeB (NB), an evolved NodeB (eNB), an access point, a base transceiver station (BTS), a radio base station, a radio transceiver, a basic service set (BSS), an extended service set (ESS), a home NodeB (HNB), a home evolved NodeB, a transmitting receiving point (TRP), or another suitable term in the field provided that a same technical effect is achieved. The base station is not limited to a specific technical term. It should be noted that, in the embodiments of this application, only a base station in an NR system is used as an example for description, but a specific type of the base station is not limited.

In order to better understand embodiments of this application, the following content is first described.

In this embodiment of this application, an amplifier may also be referred to as one of the following: a signal amplifier, a repeater, a smart repeater, a network controlled repeater (NCR), or the like. This is not limited thereto. The amplifier may be configured to extend a coverage area of a cell, or to supplement a coverage blind area, including receiving and amplifying a downlink signal from an upstream base station (host), so that strength of the signal that arrives at a terminal increases; and amplifying an uplink signal from the terminal, so that strength of the uplink signal from the terminal to the upstream base station increases.

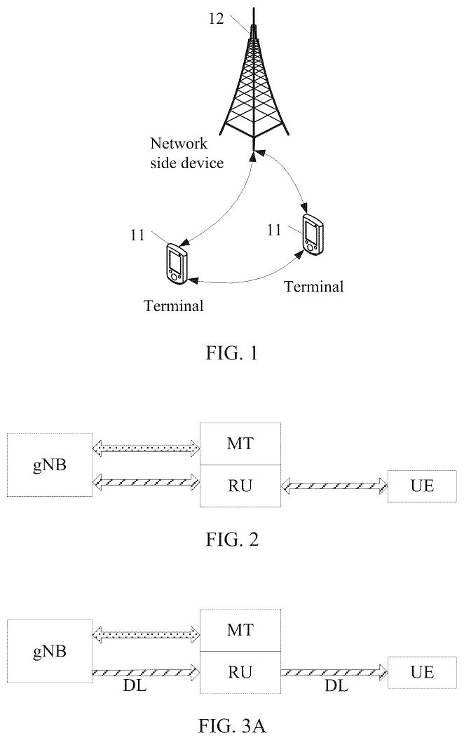

The amplifier may receive control from an upstream base station (parent node) or a donor base station, that is, the base station may control a transmit parameter of the amplifier, such as a switch and/or a transmit beam of the amplifier, to improve operating efficiency of the amplifier and reduce interference. A network structure shown in FIG. 2 includes three network nodes, and an intermediate network node is an amplifier. The intermediate network node includes a mobile termination (MT) and a radio unit (RU). The RU may also be represented as an RF unit (radio frequency unit), or an amplifier unit (repeater unit). It is not excluded that the amplifier contains only one of the MT and the RU. The MT may be connected to an upstream base station (for example, a gNB), and the base station may exchange control signaling with the amplifier by using the MT, so as to indicate a transmit/receive related parameter of the MT/RU of the amplifier.

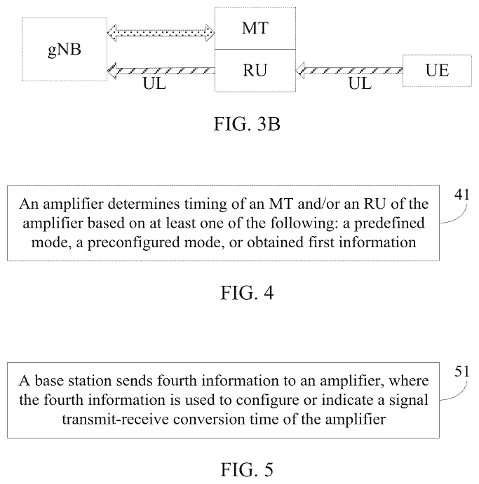

For the network structure shown in FIG. 2, there are downlink DL transmission and uplink UL transmission between the gNB and the MT. If a UL signal is transmitted, a link involved is MT TX/MT UL, that is, gNB RX. If a DL signal is transmitted, a link involved is MT RX/MT DL, that is, gNB TX. TX indicates transmitting and RX indicates receiving. There are DL transmission and UL transmission between the gNB and the UE. If a DL signal sent by the gNB is forwarded to UE after DL amplification by an amplifier, a link between the gNB and the RU is an RU DL RX link, that is, a gNB DL TX link, and a link between the RU and the UE is an RU DL TX link, that is, a UE DL RX link, as shown in FIG. 3A. If a UL signal sent by UE is forwarded to the gNB after UL amplification by an amplifier, a link between the UE and the RU is an RU UL RX link, that is, a UE UL TX link, and a link between the RU and the gNB is an RU UL TX link, that is, a gNB UL RX link, as shown in FIG. 3B. The RU has a delay of about 5 μs between receiving a signal and forwarding the signal.

There are a plurality of link states on the amplifier, such as MT TX/MT UL, MT RX/MT DL, RU UL RX, RU UL TX, RU DL RX, and RU DL TX.

In addition, a smart repeater may be replaced with a reconfigurable intelligent surface (RIS) or a remote radio unit (RRU) of the base station. The MT part may also be a repeater controller control unit.

After a classic signal amplifier is powered on, the amplifier works continuously for amplification, without switching ON/OFF to save power. When no signal needs to be forwarded, an interference signal and a noise signal from other cells may be amplified, thus interfering with reception of a current cell, and a side lobe of a signal sent by the current cell and a noise signal may be sent to other cells, thus interfering with reception of the other cells. This causes serious system interference. Therefore, the ON/OFF mode of the repeater may be considered to reduce interference caused by noise amplification in the system. In addition, when no signal needs to be forwarded, power consumption of the repeater may be reduced by disabling repeater forwarding, thereby realizing power saving.

It should be noted that the ON state of the amplifier mentioned herein refers to a state in which the RU part normally amplifies and transmits an input signal. The OFF state of the amplifier mentioned herein refers to a state in which the RU part does not amplify and transmit an input signal, and may be one of the following states: an RU sleep state, a low output power state, a low magnification state, or a power-off state.

There are a plurality of link states on the amplifier, such as MT TX/MT UL, RU UL RX, RU UL TX, and the like. If a plurality of sets of UL timing are maintained, complexity of signal processing may be improved. If only one set of UL timing is maintained, but transmitted UL signals are non-slot boundary aligned or non-symbol boundary aligned, interference between symbols is generated, resulting in poor UL signal performance and low demodulation success rate. Therefore, UL timing of the amplifier needs to be considered. For DL, same as UL. At the same time, the conversion between receiving and transmitting on the amplifier may need processing time, which has an effect when considering a timing scheme. Therefore, timing adjustment on the amplifier needs to be considered, so that good signal transmitting and receiving can be carried out among the base station, the amplifier, and the terminal, and interference between slots/symbols is reduced.

Optionally, the RU UL in this application refers to an uplink forwarding state of the RU (for example, including an RU UL RX link state and an RU UL TX link state), and the RU DL in this application refers to a downlink forwarding state of the RU (for example, including an RU DL RX link state and an RU DL TX link state).

The following describes in detail a timing adjustment method, a configuration method, an apparatus, an amplifier, and a base station provided in the embodiments of this application by using some embodiments and application scenarios thereof with reference to the accompanying drawings.

FIG. 4 is a flowchart of a timing adjustment method according to an embodiment of this application. The method is applied to an amplifier, and the amplifier may be an NCR or the like. As shown in FIG. 4, the method includes the following step.

Step 41: The amplifier determines timing of an MT and/or an RU of the amplifier based on at least one of the following: a predefined mode, a preconfigured mode, or obtained first information.

Optionally, the foregoing first information may include but is not limited to at least one of the following:
radio resource control (RRC) signaling, a medium access control control element (MAC CE), downlink control information (DCI), downlink data, a service request (SR), a physical random access channel (PRACH), a physical uplink control channel (PUCCH), uplink data, or the like.

Optionally, the foregoing first information may include timing mode information, so that the amplifier determines, based on the timing mode information, the timing of the MT and/or the RU of the amplifier in a corresponding timing mode.

In some embodiments, the amplifier may determine the timing of the MT and/or the RU of the amplifier based on the predefined mode or the preconfigured mode. That is, the timing of the MT and/or the RU of the amplifier may be directly determined in a certain mode without receiving data/signaling.

In some other embodiments, after obtaining the first information, the amplifier may determine the timing of the MT and/or the RU of the amplifier based on the obtained first information. The first information may be downlink signaling/data (such as RRC signaling, MAC CE, DCI, or the like) from a base station, and the downlink signaling may instruct the amplifier to perform timing adjustment and/or indicate a timing adjustment mode. The first information may alternatively be uplink signaling/data (such as an SR, a PRACH, uplink data, or the like) from a terminal. The uplink signaling may instruct the amplifier to perform timing adjustment and/or indicate a timing adjustment mode. However, it should be noted that uplink signaling and downlink signaling may not indicate timing adjustment related content, that is, after obtaining the signaling/data of the base station and/or the terminal, the amplifier may determine the timing of the MT and/or the RU of the amplifier in a certain mode. The first information may include the timing mode information, which is used to determine a timing mode of the NCR.

In some other embodiments, the amplifier may determine the timing of the MT and/or the RU of the amplifier based on the predefined mode and the obtained first information. That is, after obtaining the signaling/data of the base station and/or the terminal, the amplifier may determine the timing of the MT and/or the RU of the amplifier in a certain mode.

According to the timing adjustment method in this embodiment of this application, the amplifier determines the timing of the MT and/or the RU in the predefined mode, the preconfigured mode, and/or the obtained first information. Therefore, timing of the amplifier can be determined, so as to ensure uplink and downlink timing alignment and reduce interference between slots/symbols.

In this embodiment of this application, the timing of the MT and/or the RU of the amplifier may include downlink timing (DL timing) and/or uplink timing (UL timing), as described below, respectively.

(1) The DL timing of the MT and/or the RU satisfies at least one of the following:
1) Receive timing and/or the downlink timing of the MT is determined based on downlink timing of a base station. That is, the MT RX timing/MT DL timing is determined based on the DL timing of the gNB.
2) Downlink receive timing of the RU is aligned with receive timing and/or the downlink timing of the MT. That is, the RU DL RX timing is aligned with the MT RX timing/MT DL timing; or downlink receive timing of the RU (the RU DL RX timing) is determined based on the DL timing of the gNB.
3) Downlink transmit timing of the RU is determined based on downlink receive timing of the RU. That is, the RU DL TX timing is determined based on the RU DL RX timing, the RU DL TX timing is determined based on the MT RX timing/MT DL timing; or the RU DL RX timing is determined based on the DL timing of the gNB.

Optionally, in 3), the downlink transmit timing of the RU is a first time delayed after the downlink receive timing of the RU, that is, the RU DL TX is transmitted the first time delayed after the RU DL RX is transmitted. The first time may be set according to an actual requirement, for example, x1 μs. This is not limited thereto.

(2) For the UL timing of the MT and/or the RU, there may be two cases:

Case 1: The UL timing of the MT and/or the RU satisfies at least one of the following:
4) Transmit timing and/or the uplink timing of the MT is determined based on timing advance (TA) signaling of the MT. That is, the MT TX timing/MT UL timing is determined based on the MT TA signaling.
5) Uplink transmit timing of the RU is aligned with the uplink timing of the MT. That is, the RU UL TX timing is aligned with the MT UL timing; or the RU UL TX timing is determined based on the MT TA signaling.
6) Uplink receive timing of the RU is determined based on uplink transmit timing of the RU. That is, the RU UL RX timing is determined based on the RU UL TX timing; the RU UL RX timing is determined based on the MT UL timing; or the RU UL RX timing is determined based on the MT TA signaling.

Optionally, in 6), the uplink receive timing of the RU is a second time advanced before the uplink transmit timing of the RU, that is, the RU UL RX is received at timing that is the second time advanced before the RU UL TX is received. The second time may be set according to an actual requirement, for example, x2 μs. This is not limited thereto.

Case 2: The UL timing of the MT and/or the RU satisfies at least one of the following:
7) Uplink receive timing of the RU is determined based on second information, where the second information includes at least one of the following: uplink timing of a terminal, transmit timing of a terminal, or transmit timing of a next-hop node of the RU. That is, the RU UL RX timing is determined based on the TX timing of the next-hop node of the UE UL/UE TX.
8) Uplink transmit timing of the RU is determined based on uplink receive timing of the RU. That is, the RU UL TX timing is determined based on the RU UL RX timing; or the RU UL TX timing is determined based on uplink timing of a terminal, transmit timing of a terminal, and/or transmit timing of a next-hop node of the RU.

Optionally, in 8), the uplink transmit timing of the RU is a second time delayed after the uplink receive timing of the RU, that is, the RU UL TX is transmitted the second time delayed after the RU UL RX is transmitted. The second time may be set according to an actual requirement, for example, x2 μs. This is not limited thereto.
9) Uplink transmit timing of the RU is aligned with the uplink timing and/or transmit timing of the MT, or uplink transmit timing of the RU is not expected to be not aligned with the uplink timing and/or transmit timing of the MT by the amplifier. That is, the RU UL TX timing is aligned with the MT UL timing/MT TX timing; or the RU UL TX timing is not expected to be not aligned with the MT UL timing/MT TX timing by the repeater. The alignment of the UL timing is ensured by the network by controlling the UE TA. Alternatively, the RU UL TX timing is determined based on the RU UL RX timing; or the RU UL TX timing is determined based on uplink timing of a terminal, transmit timing of a terminal, and/or transmit timing of a next-hop node of the RU.

It should be noted that the foregoing first time and second time may be the same or different. An alignment sequence of the foregoing case 1 and case 2 is different, but a timing result obtained is the same.

Optionally, the first time and/or the second time satisfies at least one of the following:
a) The first time and/or the second time is one of the following: a predefined value, a preconfigured value, or a network configured value.

For example, both the first time and the second time are equal to 5 μs or 10 μs. Alternatively, the first time is equal to 5 μs, and the second time is equal to 10 μs. Alternatively, the first time is equal to 10 μs, and the second time is equal to 5 μs.
b) The first time and/or the second time is related to a sub-carrier space (SCS) or a frequency range (FR).

Optionally, in a case that the first time and/or the second time is related to the SCS, the first time and/or the second time is equal to X/2^{u}, or the first time and/or the second time is equal to X/u, where X is one of the following: a predefined value, a preconfigured value, or a network configured value; and u is a parameter corresponding to the SCS.

For example, if SCS=15 kHz, then u=0. If SCS-30 kHz, then u=1. If SCS-60 kHz, then u=2. If SCS=120 kHz, then u=3. If SCS=240 kHz, then u=4. If SCS=480 kHz, then u=5. If SCS=960 kHz, then u=6.
c) The first time and/or the second time is an implementation-based value.

For example, a protocol may require the first time and/or the second time to be greater than/equal to a processing time at which the amplifier receives and forwards a signal. Alternatively, a value of the first time and/or the second time is not less than X1 or greater than X1, where X1 is a predefined/preconfigured processing time at which the amplifier receives and forwards a signal. Optionally, X1 is related to the SCS, and a mapping relationship between a value of X1 and the SCS may be predefined/preconfigured.
d) The first time and/or the second time is not less than a third time or greater than a third time.

Optionally, the third time may satisfy at least one of the following:
the third time is a predefined or preconfigured signal transmit-receive conversion time of the amplifier; or
the third time is related to the SCS, for example, a mapping relationship between a value of the third time and the SCS may be predefined/preconfigured.

Optionally, to better ensure timing adjustment, the amplifier may report the first time and/or the second time, and/or report a reference SCS and/or a frequency range, so that the base station learns a corresponding conversion time.

In this embodiment of this application, a turn-on state (ON state) of the amplifier may be controlled, so as to reduce interference. The terminal may determine a turn-on time of the amplifier based on third information. The turn-on time of the amplifier may be understood as a start location of an available resource of the amplifier or a start location of transmission. The third information may include at least one of the following: the uplink transmit timing of the RU, the uplink timing of the MT, or a start time of a time unit of the RU. The time unit may include but is not limited to a slot, a symbol, a subframe, a preset pattern, and the like.

Optionally, in a case of determining the turn-on time of the amplifier based on the uplink transmit timing of the RU, an uplink start time of the RU is a fourth time advanced before the uplink transmit timing of the RU; and/or in a case of determining the turn-on time of the amplifier based on the uplink timing of the MT, an uplink start time of the RU is a fifth time advanced before the uplink timing of the MT. That is, the RU UL is turned on or in an ON state at least at a preset time before the RU UL TX/MT UL.

Optionally, in a case of determining the turn-on time of the amplifier based on a transmission start time of the RU, the turn-on time of the amplifier is a sixth time advanced before the start time of the time unit of the RU. For example, the amplifier is turned on or in an ON state at a preset time before the RU slot/symbol start location.

It should be noted that the fourth time, the fifth time, and the sixth time may be set according to an actual requirement, and may be the same or different. This is not limited thereto.

Optionally, the fourth time, the fifth time, and the sixth time may satisfy at least one of the following:
a) At least one of the fourth time, the fifth time, or the sixth time is one of the following: a predefined value, a preconfigured value, or a network configured value.

For example, the fourth time, the fifth time, and the sixth time are all equal to 5 μs or 10 μs.
b) At least one of the fourth time, the fifth time, or the sixth time is related to an SCS or a frequency range.

Optionally, in a case that at least one of the fourth time, the fifth time, or the sixth time is related to the SCS, at least one of the fourth time, the fifth time, or the sixth time is equal to X/2^{u}, or at least one of the fourth time, the fifth time, or the sixth time is equal to X/u where X is one of the following: a predefined value, a preconfigured value, or a network configured value; and u is a parameter corresponding to the SCS.

For example, if SCS=15 kHz, then u=0. If SCS=30 kHz, then u=1. If SCS=60 kHz, then u=2. If SCS=120 kHz, then u=3. If SCS=240 kHz, then u=4. If SCS=480 kHz, then u=5. If SCS=960 kHz, then u=6.
c) At least one of the fourth time, the fifth time, or the sixth time is an implementation-based value.

For example, a protocol may require at least one of the fourth time, the fifth time, or the sixth time to be greater than/equal to a processing time at which the amplifier receives and forwards a signal. Alternatively, a value of at least one of the fourth time, the fifth time, or the sixth time is not less than X1, where X1 is a predefined/preconfigured processing time at which the amplifier receives and forwards a signal. Optionally, X1 is related to the SCS, and a mapping relationship between a value of X1 and the SCS may be predefined/preconfigured.
d) At least one of the fourth time, the fifth time, or the sixth time is not less than a seventh time or greater than a seventh time.

Optionally, the seventh time may satisfy at least one of the following:
the seventh time is a predefined or preconfigured signal transmit-receive conversion time of the amplifier; or
the seventh time is related to the SCS, for example, a mapping relationship between a value of the seventh time and the SCS may be predefined/preconfigured.
e) The fourth time, the fifth time, and the sixth time are the same or different.

FIG. 5 is a flowchart of a configuration method according to an embodiment of this application. The method is applied to a base station. As shown in FIG. 5, the method includes the following step.

Step 51: The base station sends fourth information to an amplifier, where the fourth information is used to configure or indicate a signal transmit-receive conversion time of the amplifier.

In this way, the amplifier may determine timing of an MT and/or an RU of the amplifier based on the configuration or indication of the signal transmit-receive conversion time of the amplifier, thereby ensuring uplink/downlink timing alignment and reducing interference between slots/symbols.

For example, the foregoing configured or indicated signal transmit-receive conversion time of the amplifier is equal to the first time and/or the second time in the foregoing embodiment, that is, a conversion time of RU DL RX→RU DL TX, and/or a conversion time of RU UL RX→RU UL TX. The two conversion times may be the same or different.

Optionally, the signal transmit-receive conversion time of the amplifier satisfies at least one of the following:
the signal transmit-receive conversion time of the amplifier is related to an SCS or a frequency range;
the signal transmit-receive conversion time of the amplifier is an implementation-based value; or
the signal transmit-receive conversion time of the amplifier is not less than an eighth time, or is greater than an eighth time.

Optionally, in a case that the signal transmit-receive conversion time of the amplifier is related to the SCS, the signal transmit-receive conversion time of the amplifier is equal to X/2^{u}, or the signal transmit-receive conversion time of the amplifier is equal to X/u, where X is one of the following: a predefined value, a preconfigured value, and a network configured value; and u is a parameter corresponding to the SCS.

For example, if SCS=15 kHz, then u=0. If SCS=30 kHz, then u=1. If SCS-60 kHz, then u=2. If SCS=120 kHz, then u=3. If SCS-240 kHz, then u=4. If SCS=480 kHz, then u=5. If SCS=960 kHz, then u=6.

Optionally, the eighth time satisfies at least one of the following:
the eighth time is a predefined or preconfigured signal transmit-receive conversion time of the amplifier; or
the eighth time is related to the SCS.

Optionally, the signal transmit-receive conversion time of the amplifier includes at least one of the following:
a signal transmit-receive conversion time of an MT of the amplifier; or
a signal transmit-receive conversion time of an RU of the amplifier.

Optionally, the base station may receive a reference SCS and/or a frequency range reported by the amplifier, so as to ensure timing adjustment.

The following describes this application with reference to specific instances.

### Instance 1:

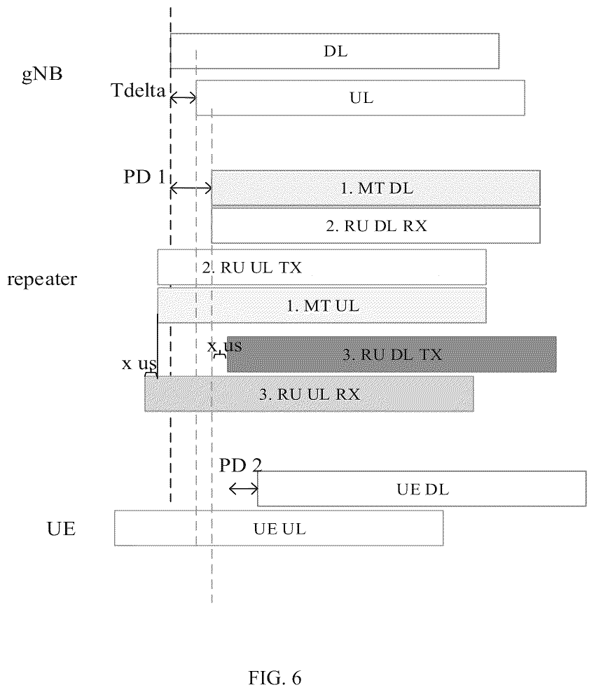

In Instance 1, as shown in FIG. 6, MT/RU DL timing may include:
1) gNB sends DL data, and a repeater determines MT DL/MT RX timing based on the received DL data.
2) RU DL RX timing is aligned with the MT DL timing; in other words, the RU DL TX determines timing based on the DL data sent by the gNB.
3) RU DL TX is sent x μs after RU DL RX is sent, where x is a predefined value, or a value determined based on a gNB configuration.

MT/RU UL timing may include:
1) gNB sends MT TA information, and a repeater MT determines MT UL timing based on MT DL and MT TX.
2) The gNB sends UE TA information, and UE determines UE UL RX, that is, RU UL TX timing, based on UE DL information and the UE TA information.
3) A repeater RU determines RU UL RX timing based on UE UL.
4) Repeater RU UL TX is sent x μs after the RU UL TX timing. The repeater does not expect the RU UL TX to be not aligned with the MT UL.

It should be noted that a value of a transmission delay Tdelta shown in FIG. 6 may be 0 or not 0.

### Instance 2:

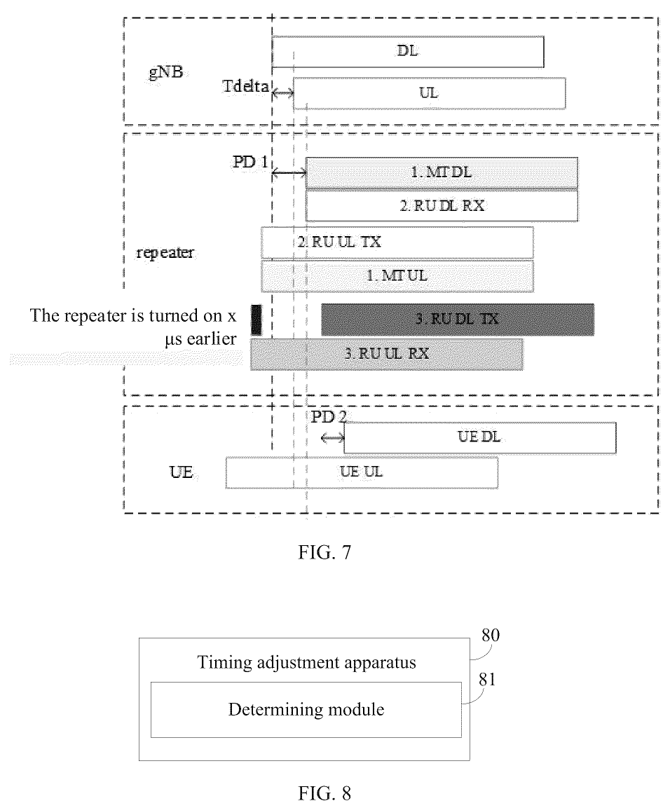

In Instance 2, as shown in FIG. 7, a repeater is at a transmission start location of an RU, or an optional transmission start location, such as a slot/symbol boundary, is turned on x us advanced before the MT UL, for example, x is equal to 5 μs, or x is equal to 10 μs, and x is related to an SCS. In this way, by turning on the repeater x μs earlier, it can be ensured that the RU UL TX is forwarded out of at the slot boundary/symbol boundary, and the gNB can receive data of the entire slot/symbol. Otherwise, if the repeater is not turned on earlier, that is, turned on at the slot boundary, then x μs before the RU UL TX is in a non-amplified forwarding state, and data cannot be forwarded to the gNB during the former x μs, resulting in data loss. Considering the RU RX→TX conversion time of x μs, the RU ON time need to be x μs earlier then the slot/symbol boundary, so that integrity of data forwarded by the RU UL to the gNB can be ensured.

The timing adjustment method provided in the embodiments of this application may be executed by a timing adjustment apparatus. In this embodiment of this application, an example in which the timing adjustment apparatus executes the timing adjustment method is used to describe the timing adjustment apparatus provided in this embodiment of this application.

FIG. 8 is a schematic diagram of a structure of a timing adjustment apparatus according to an embodiment of this application. The apparatus is used in an amplifier. As shown in FIG. 8, a timing adjustment apparatus 80 includes:
a determining module 81, configured to determine timing of a mobile termination MT and/or a radio unit RU of an amplifier based on at least one of the following: a predefined mode, a preconfigured mode, or obtained first information.

Optionally, the first information includes at least one of the following:
radio resource control RRC signaling, a medium access control control element MAC CE, downlink control information, downlink data, a service request, a physical random access channel PRACH, a physical uplink control channel PUCCH, or uplink data.

Optionally, the timing includes downlink timing of the MT and/or the RU, and the downlink timing satisfies at least one of the following:
receive timing and/or the downlink timing of the MT is determined based on downlink timing of a base station;
downlink receive timing of the RU is aligned with receive timing and/or the downlink timing of the MT; or
downlink transmit timing of the RU is determined based on downlink receive timing of the RU; and/or
the timing includes uplink timing of the MT and/or the RU, and the uplink timing satisfies at least one of the following:
transmit timing and/or the uplink timing of the MT is determined based on timing advance TA signaling of the MT;
uplink transmit timing of the RU is aligned with the uplink timing of the MT; or
uplink receive timing of the RU is determined based on uplink transmit timing of the RU; and/or
the timing includes uplink timing of the MT and/or the RU, and the uplink timing satisfies at least one of the following:
uplink receive timing of the RU is determined based on second information, where the second information includes at least one of the following: uplink timing of a terminal, transmit timing of a terminal, or transmit timing of a next-hop node of the RU;
uplink transmit timing of the RU is determined based on uplink receive timing of the RU; or
uplink transmit timing of the RU is aligned with the uplink timing and/or transmit timing of the MT, or uplink transmit timing of the RU is not expected to be not aligned with the uplink timing and/or transmit timing of the MT by the amplifier.

Optionally, in a case that the downlink transmit timing of the RU is determined based on the downlink receive timing of the RU, the downlink transmit timing of the RU is first time delayed after the downlink receive timing of the RU;
in a case that the uplink receive timing of the RU is determined based on the uplink transmit timing of the RU, the uplink receive timing of the RU is a second time advanced before the uplink transmit timing of the RU; or
in a case that the uplink transmit timing of the RU is determined based on the uplink receive timing of the RU, the uplink transmit timing of the RU is second time delayed after the uplink receive timing of the RU.

Optionally, the first time and/or the second time satisfies at least one of the following:
the first time and/or the second time is one of the following: a predefined value, a preconfigured value, or a network configured value;
the first time and/or the second time is related to a sub-carrier space SCS;
the first time and/or the second time is related to a frequency range;
the first time and/or the second time is an implementation-based value;
the first time and/or the second time is not less than a third time or greater than a third time; or
the first time and the second time are the same or different.

Optionally, in a case that the first time and/or the second time is related to the SCS, the first time and/or the second time is equal to X/2^{u}, or the first time and/or the second time is equal to X/u, where X is one of the following: a predefined value, a preconfigured value, or a network configured value; and u is a parameter corresponding to the SCS.

Optionally, the third time satisfies at least one of the following:
the third time is a predefined or preconfigured signal transmit-receive conversion time of the amplifier; or
the third time is related to the SCS.

Optionally, the timing adjustment apparatus 80 includes:
a reporting module, configured to report the first time and/or the second time; and/or report a reference SCS and/or a frequency range.

Optionally, the determining module 81 is further configured to:
determine a turn-on time of the amplifier based on third information, where
the third information includes at least one of the following:
the uplink transmit timing of the RU, the uplink timing of the MT, or a start time of a time unit of the RU.

Optionally, in a case of determining the turn-on time of the amplifier based on the uplink transmit timing of the RU, an uplink start time of the RU is a fourth time advanced before the uplink transmit timing of the RU; and/or
in a case of determining the turn-on time of the amplifier based on the uplink timing of the MT, an uplink start time of the RU is a fifth time advanced before the uplink timing of the MT; and/or
in a case of determining the turn-on time of the amplifier based on a transmission start time of the RU, the turn-on time of the amplifier is a sixth time advanced before the start time of the time unit of the RU.

Optionally, the fourth time, the fifth time, and the sixth time satisfy at least one of the following:
at least one of the fourth time, the fifth time, or the sixth time is one of the following: a predefined value, a preconfigured value, or a network configured value;
at least one of the fourth time, the fifth time, or the sixth time is related to an SCS;
at least one of the fourth time, the fifth time, or the sixth time is related to a frequency range;
at least one of the fourth time, the fifth time, or the sixth time is an implementation-based value;
at least one of the fourth time, the fifth time, or the sixth time is not less than a seventh time or greater than a seventh time; or
the fourth time, the fifth time, and the sixth time are the same or different.

Optionally, in a case that at least one of the fourth time, the fifth time, or the sixth time is related to the SCS, at least one of the fourth time, the fifth time, or the sixth time is equal to X/2^{u}, or at least one of the fourth time, the fifth time, or the sixth time is equal to X/u, where X is one of the following: a predefined value, a preconfigured value, or a network configured value; and u is a parameter corresponding to the SCS.

Optionally, the seventh time satisfies at least one of the following:
the seventh time is a predefined or preconfigured signal transmit-receive conversion time of the amplifier; or
the seventh time is related to the SCS.

The timing adjustment apparatus 80 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a network attached storage (NAS), or the like. This is not specifically limited in the embodiments of this application.

The timing adjustment apparatus 80 provided in this embodiment of this application can implement the processes implemented in the method embodiment of FIG. 4, and achieve a same technical effect. To avoid repetition, details are not described herein again.

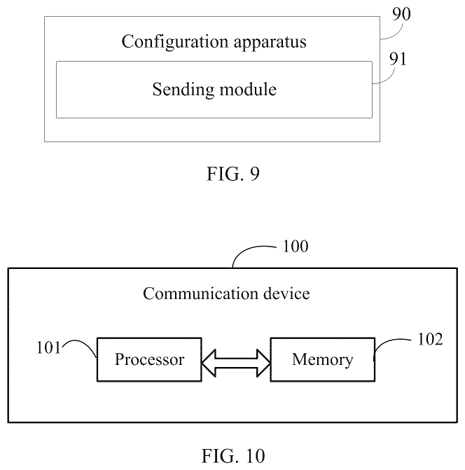

FIG. 9 is a schematic diagram of a structure of a configuration apparatus according to an embodiment of this application. The apparatus is used in a base station. As shown in FIG. 9, a configuration apparatus 90 includes:
a sending module 91, configured to send fourth information to an amplifier, where the fourth information is used to configure or indicate a signal transmit-receive conversion time of the amplifier.

Optionally, the signal transmit-receive conversion time of the amplifier satisfies at least one of the following:
the signal transmit-receive conversion time of the amplifier is related to an SCS or a frequency range;
the signal transmit-receive conversion time of the amplifier is an implementation-based value; or
the signal transmit-receive conversion time of the amplifier is not less than an eighth time, or is greater than an eighth time.

Optionally, in a case that the signal transmit-receive conversion time of the amplifier is related to the SCS, the signal transmit-receive conversion time of the amplifier is equal to X/2^{u}, or the signal transmit-receive conversion time of the amplifier is equal to X/u, where X is one of the following: a predefined value, a preconfigured value, and a network configured value; and u is a parameter corresponding to the SCS.

Optionally, the eighth time satisfies at least one of the following:
the eighth time is a predefined or preconfigured signal transmit-receive conversion time of the amplifier; or
the eighth time is related to the SCS.

Optionally, the signal transmit-receive conversion time of the amplifier includes at least one of the following:
a signal transmit-receive conversion time of an MT of the amplifier; or
a signal transmit-receive conversion time of an RU of the amplifier.

Optionally, the configuration apparatus 90 further includes:
a receiving module, configured to receive a reference SCS and/or a frequency range reported by the amplifier.

The configuration apparatus 90 provided in this embodiment of this application can implement the processes implemented in the method embodiment shown in FIG. 5, and achieve a same technical effect. To avoid repetition, details are not described herein again.

Optionally, as shown in FIG. 10, an embodiment of this application further provides a communication device 100, including a processor 101 and a memory 102, and the memory 102 stores a program or an instruction that can be run on the processor 101. For example, in a case that the communication device 100 is an amplifier, the program or the instruction is executed by the processor 101 to implement the steps of the foregoing timing adjustment method embodiment, and achieve a same technical effect. In a case that the communication device 100 is a base station, the program or the instruction is executed by the processor 101 to implement the steps of the foregoing configuration method embodiment, and achieve a same technical effect. To avoid repetition, details are not described herein again.

An embodiment of this application further provides a readable storage medium. The readable storage medium stores a program or an instruction, and the program or the instruction is executed by a processor to implement the processes of the foregoing timing adjustment method embodiment, or to implement the processes of the foregoing configuration method embodiment, and achieve a same technical effect. To avoid repetition, details are not described herein again.

The processor is a processor in the amplifier in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or an instruction, to implement the processes of the foregoing timing adjustment method embodiment, or to implement the processes of the foregoing configuration method embodiment, and achieve a same technical effect. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a non-transient storage medium, and the computer program/program product is executed by at least one processor to implement the processes of the foregoing timing adjustment method embodiment, or to implement the processes of the foregoing configuration method embodiment, and achieve a same technical effect. To avoid repetition, details are not described herein again.

An embodiment of this application further provides a communication system, including an amplifier and a base station. The amplifier may be configured to perform the steps of the timing adjustment method as described above, and the base station may be configured to perform the steps of the configuration method as described above.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a hardware platform or by hardware only. Based on such an understanding, the technical solutions of this application may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A timing adjustment method, comprising:
an amplifier determines timing of a mobile termination (MT) and/or a radio unit (RU) of the amplifier based on at least one of the following: a predefined mode, a preconfigured mode, or obtained first information.

2. The method according to claim 1, wherein the first information comprises:
a medium access control control element (MAC CE).

3. The method according to claim 1, wherein the timing comprises downlink timing of the MT and/or the RU, and the downlink timing satisfies at least one of the following:
downlink receive timing of the RU is aligned with receive timing and/or the downlink timing of the MT; or
downlink transmit timing of the RU is determined based on downlink receive timing of the RU; and/or
the timing comprises uplink timing of the MT and/or the RU, and the uplink timing satisfies at least one of the following:
transmit timing and/or the uplink timing of the MT is determined based on timing advance (TA) signaling of the MT;
uplink transmit timing of the RU is aligned with the uplink timing of the MT; or
uplink receive timing of the RU is determined based on uplink transmit timing of the RU.

4. The method according to claim 3, wherein in a case that the downlink transmit timing of the RU is determined based on the downlink receive timing of the RU, the downlink transmit timing of the RU is first time delayed after the downlink receive timing of the RU; or
in a case that the uplink receive timing of the RU is determined based on the uplink transmit timing of the RU, the uplink receive timing of the RU is a second time advanced before the uplink transmit timing of the RU.

5. The method according to claim 4, wherein the first time and/or the second time satisfies at least one of the following:
the first time and/or the second time is one of the following: a predefined value, a preconfigured value, or a network configured value;
the first time and/or the second time is related to a sub-carrier space (SCS);
the first time and/or the second time is related to a frequency range;
the first time and/or the second time is an implementation-based value;
the first time and/or the second time is not less than a third time or greater than a third time; or
the first time and the second time are the same or different;
wherein the third time satisfies at least one of the following:
the third time is a predefined or preconfigured signal transmit-receive conversion time of the amplifier; or
the third time is related to the SCS.

6. The method according to claim 5, wherein in a case that the first time and/or the second time is related to the SCS, the first time and/or the second time is equal to X/2^{u}, or the first time and/or the second time is equal to X/u, wherein X is one of the following: a predefined value, a preconfigured value, or a network configured value; and u is a parameter corresponding to the SCS.

7. The method according to claim 4, wherein the method further comprises at least one of the following:
reporting, by the amplifier, the first time and/or the second time; or
reporting, by the amplifier, a reference SCS and/or a frequency range.

8. The method according to claim 1, wherein the method further comprises:
determining, by the amplifier, a turn-on time of the amplifier based on third information, wherein
the third information comprises at least one of the following:
the uplink transmit timing of the RU, the uplink timing of the MT, or a start time of a time unit of the RU;
wherein in a case of determining the turn-on time of the amplifier based on the uplink transmit timing of the RU, an uplink start time of the RU is a fourth time advanced before the uplink transmit timing of the RU; and/or
in a case of determining the turn-on time of the amplifier based on the uplink timing of the MT, an uplink start time of the RU is a fifth time advanced before the uplink timing of the MT; and/or
in a case of determining the turn-on time of the amplifier based on a transmission start time of the RU, the turn-on time of the amplifier is a sixth time advanced before the start time of the time unit of the RU;
wherein the fourth time, the fifth time, and the sixth time satisfy at least one of the following:
at least one of the fourth time, the fifth time, or the sixth time is one of the following: a predefined value, a preconfigured value, or a network configured value;
at least one of the fourth time, the fifth time, or the sixth time is related to an SCS;
at least one of the fourth time, the fifth time, or the sixth time is related to a frequency range;
at least one of the fourth time, the fifth time, or the sixth time is an implementation-based value;
at least one of the fourth time, the fifth time, or the sixth time is not less than a seventh time or greater than a seventh time; or
the fourth time, the fifth time, and the sixth time are the same or different.

9. The method according to claim 8, wherein in a case that at least one of the fourth time, the fifth time, or the sixth time is related to the SCS, at least one of the fourth time, the fifth time, or the sixth time is equal to X/2^{u}, or at least one of the fourth time, the fifth time, or the sixth time is equal to X/u, wherein X is one of the following: a predefined value, a preconfigured value, or a network configured value; and u is a parameter corresponding to the SCS.

10. The method according to claim 8, wherein the seventh time satisfies at least one of the following:
the seventh time is a predefined or preconfigured signal transmit-receive conversion time of the amplifier; or
the seventh time is related to the SCS.

11. An amplifier, comprising a processor and a memory, wherein the memory stores a program or an instruction that can be run on the processor, wherein the program or the instruction, when executed by the processor, causes the amplifier to perform:
determining timing of a mobile termination (MT) and/or a radio unit (RU) of the amplifier based on at least one of the following: a predefined mode, a preconfigured mode, or obtained first information.

12. The amplifier according to claim 11, wherein the first information comprises:
a medium access control control element (MAC CE).

13. The amplifier according to claim 11, wherein the timing comprises downlink timing of the MT and/or the RU, and the downlink timing satisfies at least one of the following:
downlink receive timing of the RU is aligned with receive timing and/or the downlink timing of the MT; or
downlink transmit timing of the RU is determined based on downlink receive timing of the RU; and/or
the timing comprises uplink timing of the MT and/or the RU, and the uplink timing satisfies at least one of the following:
transmit timing and/or the uplink timing of the MT is determined based on timing advance (TA) signaling of the MT;
uplink transmit timing of the RU is aligned with the uplink timing of the MT; or
uplink receive timing of the RU is determined based on uplink transmit timing of the RU.

14. The amplifier according to claim 13, wherein in a case that the downlink transmit timing of the RU is determined based on the downlink receive timing of the RU, the downlink transmit timing of the RU is first time delayed after the downlink receive timing of the RU; or
in a case that the uplink receive timing of the RU is determined based on the uplink transmit timing of the RU, the uplink receive timing of the RU is a second time advanced before the uplink transmit timing of the RU.

15. The amplifier according to claim 14, wherein the first time and/or the second time satisfies at least one of the following:
the first time and/or the second time is one of the following: a predefined value, a preconfigured value, or a network configured value;
the first time and/or the second time is related to a sub-carrier space (SCS);
the first time and/or the second time is related to a frequency range;
the first time and/or the second time is an implementation-based value;
the first time and/or the second time is not less than a third time or greater than a third time; or
the first time and the second time are the same or different;
wherein the third time satisfies at least one of the following:
the third time is a predefined or preconfigured signal transmit-receive conversion time of the amplifier; or
the third time is related to the SCS.

16. The amplifier according to claim 15, wherein in a case that the first time and/or the second time is related to the SCS, the first time and/or the second time is equal to X/2^{u}, or the first time and/or the second time is equal to X/u, wherein X is one of the following: a predefined value, a preconfigured value, or a network configured value; and u is a parameter corresponding to the SCS.

17. A non-transitory readable storage medium, wherein the non-transitory readable storage medium stores a program or an instruction, wherein the program or the instruction, when executed by a processor of an amplifier, causes the amplifier to perform:
determining timing of a mobile termination (MT) and/or a radio unit (RU) of the amplifier based on at least one of the following: a predefined mode, a preconfigured mode, or obtained first information.

18. The non-transitory readable storage medium according to claim 17, wherein the first information comprises:
a medium access control control element (MAC CE).

19. The non-transitory readable storage medium according to claim 17, wherein the timing comprises downlink timing of the MT and/or the RU, and the downlink timing satisfies at least one of the following:
downlink receive timing of the RU is aligned with receive timing and/or the downlink timing of the MT; or
downlink transmit timing of the RU is determined based on downlink receive timing of the RU; and/or
the timing comprises uplink timing of the MT and/or the RU, and the uplink timing satisfies at least one of the following:
transmit timing and/or the uplink timing of the MT is determined based on timing advance (TA) signaling of the MT;
uplink transmit timing of the RU is aligned with the uplink timing of the MT; or
uplink receive timing of the RU is determined based on uplink transmit timing of the RU.

20. The non-transitory readable storage medium according to claim 19, wherein in a case that the downlink transmit timing of the RU is determined based on the downlink receive timing of the RU, the downlink transmit timing of the RU is first time delayed after the downlink receive timing of the RU; or
in a case that the uplink receive timing of the RU is determined based on the uplink transmit timing of the RU, the uplink receive timing of the RU is a second time advanced before the uplink transmit timing of the RU.
